(19) United States
(12) Patent Application Publication
(10) Pub. No.: US 2026/0330988 A1
(43) Pub. Date: Oct. 22, 2026

(54) ARTIFICIAL INTELLIGENCE TEACHER ASSISTANT SYSTEM

(71) Applicant: Socrait PBC, Inc., Sandy, UT (US)

(72) Inventors: Maria Andersen, Sandy, UT (US); Cameron Flint, Seattle, WA (US); Jason Palmer, Baltimore, MD (US)

(21) Appl. No.: 19/529,568

(22) Filed: Feb. 4, 2026

Related U.S. Application Data
(60) Provisional application No. 63/753,786, filed on Feb. 4, 2025.

(51) Int. Cl. G09B 5/02; G10L 17/06; G10L 25/63

(52) U.S. Cl. CPC G09B 5/02; G10L 17/06; G10L 25/63

(57) ABSTRACT

Disclosed are systems, devices, and/or methods of use thereof regarding artificial intelligence assistance tools for use by teachers. In various aspects, a method of assisting a teacher includes tracking a plurality of audio inputs, where the plurality of audio inputs are spoken by the teacher. The method may also include processing the plurality of audio inputs for one or more of a behavior content, an attendance content, an engagement content, and a lesson content. Additionally, the method may include determining one or more suggested outputs based on the processed plurality of audio inputs and generating a summary of one or more of the plurality of audio inputs based on the processed plurality of audio inputs. Further, the method may include incorporating at least a portion of the summary into an educational administrative system.

### CLAIM FOR PRIORITY

This application claims the benefit of and priority to U.S. Provisional App. No. 63/753,786 filed on Feb. 4, 2025 titled “ARTIFICIAL INTELLIGENCE TEACHER ASSISTANT SYSTEM,” the entire contents of which are herein incorporated by reference.

### TECHNICAL FIELD

This disclosure relates generally to an artificial intelligence assistant system or toolset for use by K12 teachers and college faculty, henceforth referred to as teachers.

### SUMMARY

Disclosed are systems, devices, and/or methods of use thereof regarding an artificial intelligence assistant toolset for use by teachers, principals, educators, educational staff, teacher aides, administrators, or other personnel, to save time and improve efficiency. In various aspects, a method of assisting a teacher includes tracking audio inputs, where the plurality of audio inputs are spoken by the teacher. The method may also include processing the plurality of audio inputs for one or more of behavior content, attendance or tardy content, special education content, engagement content, acknowledgment of student participation or praise, student mastery, curriculum content, hall pass content, substitute teaching content, classroom economies, and/or lesson content. Additionally, the method includes determining one or more suggested outputs based on the processed plurality of audio inputs and generating data, information, and a digital summary or transmission of one or more of the audio inputs based on the processed audio inputs. Further, the method includes incorporating at least a portion of the processed data or information into one or more educational administrative systems in particular formats.

In various aspects, a method of assisting a teacher includes receiving a plurality of audio inputs from the teacher and processing the plurality of audio inputs to create educationally and administratively useful information, such as engagement content, attendance content, etc.. The method may also include determining one or more of behavior content, attendance or tardy content, special education content, engagement content, acknowledgment of student participation or praise, or student mastery, and/or lesson content from the processed audio inputs. Additionally, the method may include generating information and reports of determined behavior content, attendance content, special education content, engagement content, student participation/praise/mastery content, and lesson content. Further, the method may include analyzing and transmitting taxonomically categorized information, content or reports (in one of the content formats) based on patterns derived. Still further, the method may include generating and transmitting information and/or reports containing information about particular interventions (behavioral, learning or administrative) based on the summarized particular content.

In various aspects, a method of assisting a teacher includes receiving a first audio input containing a first content. The method may also include analyzing the first content from the first audio input and determining a first suggested content based on the analyzed first content. Additionally, the method may include providing the first suggested content to an electronic device associated with a first audience, the first audience comprising a student.

In various aspects, a method of assisting a teacher includes receiving a plurality of audio inputs from the teacher and processing the plurality of audio inputs. The method may also include determining one or more of an attendance content, an engagement content, a behavioral content, a lesson/mastery content from the processed audio inputs. Additionally, the method may include generating a summary of student-specific attendance content, engagement content, behavioral content, participation content, and lesson/mastery content from the processed audio inputs. Further, the method may include determining one or more suggested outputs based on the student-specific summary and pushing the one or more suggested outputs to a specific student based on the student-specific summary and the determined one or more suggested outputs.

In various aspects, a system for assisting a teacher may include at least one input device and one or more processors in communication with the at least one input device. The one or more processors include memory capable of storing instructions executable by the one or more processors. The instructions cause the one or more processors to track audio inputs received by the at least one input device and analyze the audio inputs for one or more of a behavior content, an attendance content, an engagement content and/or a participation content, or a lesson/mastery content. The instructions also cause the one or more processors to generate one or more digital summary reports or transmissions corresponding to analyzed audio inputs, push the one or more summary reports to the teacher, or other educator, or administrator, and/or generate one or more suggestions based on the analyzed audio inputs, and push the one or more suggestions to one or more students or parents.

In various embodiments, the disclosed systems provide a specific improvement to computer functionality for real-time educational audio processing. The systems implement a staged pipeline that gates speech-to-text processing with voiceprint-based speaker isolation, performs constrained named-entity recognition with roster reconciliation, and applies prompt-bounded, schema-constrained large language models to emit machine-validated event objects in sub-second latency. This architecture reduces false positives by filtering non-primary speakers before transcription, thereby improving transcription accuracy and reducing compute load, memory footprint, and network bandwidth relative to naïve continuous recording and post hoc analysis. The pipeline further implements privacy-preserving anonymization via a private name key data structure that enables controlled de-anonymization during downstream event formation, thereby providing improved security characteristics not achievable with conventional, unstructured redaction approaches.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIGS. 1-4 are flowcharts of example methods according to the present disclosure;

FIG. 5 schematically illustrates a block diagram of a system capable of performing any of the methods described herein;

FIG. 6 schematically illustrates a workflow performed by the system of FIG. 5 and corresponding to at least portions of the methods described with respect to FIGS. 1-4;

FIG. 7 illustrates a feedback loop performed as part of any of the methods described herein and/or as part of the workflow performed by the system of FIG. 5;

FIG. 8 schematically illustrates another workflow performed by the system of FIG. 5 and corresponding to at least portions of the methods described with respect to FIGS. 1-4; and

FIG. 9 schematically illustrates a block diagram of a system capable of performing any of the methods described herein and providing an interactive chat-bot to users of the system.

### DETAILED DESCRIPTION

In any school setting (e.g., public, charter, private, parochial, etc.), teachers face a variety of different challenges in managing a classroom, providing effective teaching, and engaging in daily administrative and compliance activities. Generally, teachers are provided with approved curriculum and required compliance activities and must cater class content to that curriculum, compliance, and assessments. Additionally, teachers are presented with a variety of differing student competencies (e.g., reading comprehension, English as a second or third language, interests, etc.) spread out over large class sizes. For example, teachers are generally out-numbered by their students, with ratios of 1 teacher to 30-plus students per class being typical. Not only are teachers tasked with instructing their students based on the curriculum, they are also tasked with compliance activities (like attendance and behavior monitoring) and preparing students for standardized test-taking.

Teachers are generally left to their own devices to provide adequate instruction based on the approved curriculum and to track student engagement, progress, and mastery. While educational administrators and systems provide structural support to teachers, there is generally no in-classroom assistance to support teachers on a day-to-day basis, although some teachers have teaching assistants or paraeducators. Additionally, teachers are tasked with and responsible for designing lesson content to match both the approved curriculum and the capabilities of all the students in the teacher’s class.

Further, teachers are responsible for tracking their students’ progress and challenges, both academically and behaviorally, through the school-year. For example, it is up to the teacher to track attendance and report poor attendance to the school, college, or larger governmental or non-profit agency (e.g., district, university, state). It is also up to the teacher to track and report the engagement and mastery of students with lesson content and across the approved curriculum. Given how little assistance teachers receive, and how much teachers are tasked with, performing each of these functions at a high level is challenging for even the most veteran of teachers.

Systems and methods of the present disclosure provide an artificial intelligence assistant toolset for teachers to utilize in their classrooms to help track and monitor a variety of different things. For example, the disclosed systems are capable of tracking and listening to the teacher throughout the day, and pulling relevant information from what the teacher is saying. The relevant information may be considered an “event” and may incorporate or correlate to a type of data or informational content. That is, events may be recognized and extracted from the audio stream spoken by the teacher as appropriate for the particular classroom setting, students, type of school, etc. This relevant event data or information may correspond to information about attendance, substantive lesson content, homework or other assignments assigned by the teacher, information regarding one or more particular students, behaviors of one or more particular students, coaching or activity plans, or any additional content that can be recognized and extracted from an audio stream input spoken by the teacher. In some embodiments, the system provides customized content to one or more particular students based on the relevant information detected.

At the end of the day (or another desired time period), the disclosed systems can provide to the teacher a report or summary of the relevant data/information/events that were tracked and extracted throughout the day. Additionally, the disclosed systems can integrate the reports and/or summaries into a larger administrative system, such as the school’s administrative system(s) and/or the school district's administrative system(s). This enables teachers, school staff, and school administrators to accurately track and monitor what is going on administratively, academically and from a classroom behavior perspective in any given classroom, as well as track and monitor the progress of any given student. Importantly, the disclosed systems and methods go beyond simple speech-to-text architectures and integrate reports or summaries into larger educational administrative systems.

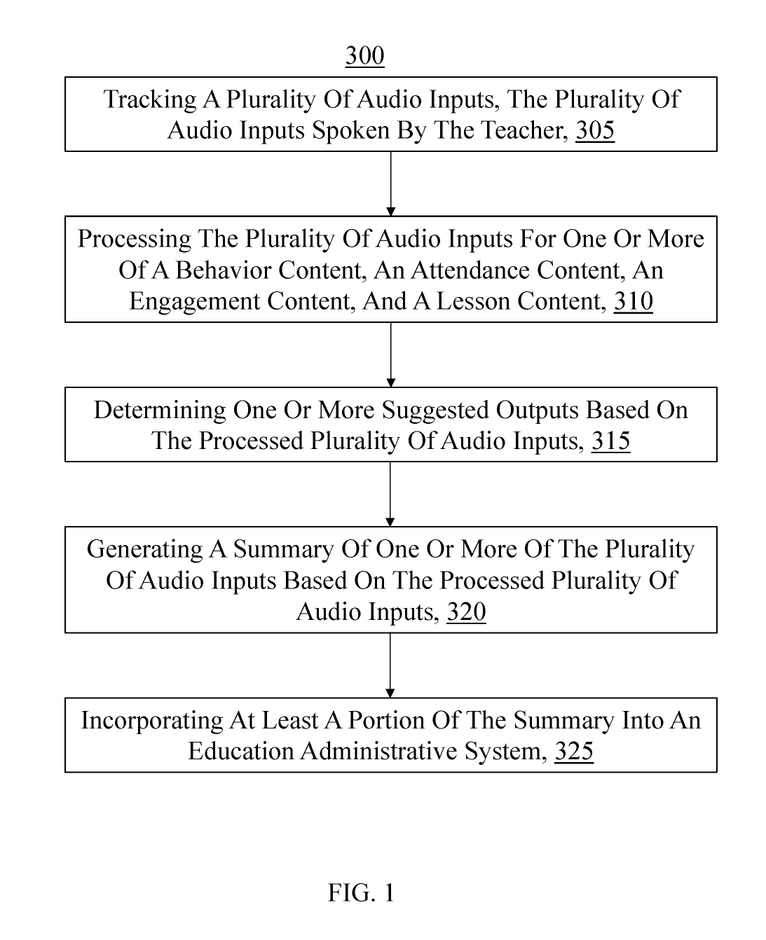

FIGS. 1-4 are flowcharts of example methods according to the present disclosure. FIG. 1 is a flowchart of one example method 300 of assisting a teacher. The method 300 may include tracking (305) a plurality of audio inputs, where the plurality of audio inputs are spoken by the teacher. The plurality of audio inputs may include a single audio input, corresponding to one class or one session held by a teacher, educator, or other personnel. Tracking the plurality of audio inputs may include listening to and for audio inputs spoken by the teacher rather than recording all audio inputs spoken by the teacher. Importantly, only audio inputs spoken by the teacher are tracked and listened to, student voices may be excluded from transmission or processing. For example, tracking the plurality of audio inputs includes receiving a first audio input and identifying a first speaker of the first audio input as a particular teacher. Tracking the plurality of audio inputs also includes receiving second audio inputs, identifying a second speaker of the second audio input, and determining which of the first speaker and the second speaker is the teacher. Audio inputs that are not spoken by the teacher(s) are ignored by the system.

Determining which speaker is the teacher includes comparing the first audio input and the second audio input to a voice print of the teacher. The voice print may be stored in a database accessible by one or more systems of the present disclosure. Additionally, the voice print may be updated and calibrated in a predetermined time period (e.g., monthly, seasonally, yearly, etc.) to account for and learn the subtle intricacies of each teacher’s voice. Upon enrollment, the teacher may record a short calibration script to generate the initial voiceprint vector. The system may periodically prompt for automatic re-calibration when similarity scores degrade below a drift threshold or upon a change in environment. To prevent erroneous writes, events below a minimum confidence threshold are placed into a pending queue for teacher confirmation via the user interface. Confirmed events are marked with a confirmation flag stored alongside the event in persistent storage.

Which of the first speaker and the second speaker is the teacher is determined based on a match between the first audio input or the second audio input(s) and the voice print of the teacher. For example, a speaker isolation system may access a voice print of the teacher and compare the received first and second audio inputs to the stored voice print of the teacher. If the first and/or second audio inputs include multiple speakers (e.g., more than one), speakers not identified as the teacher may be filtered out and ignored. A non-teacher speaker may be identified by a mismatch between the speaker and the stored voice print.

Additionally, and/or alternatively, systems of the present disclosure may record each teacher’s audio and speech during a first-time sign-up and/or at the beginning of each class in order to make a voice print of the teacher. The voice print may be stored in a database accessible by one or more systems of the present disclosure. Additionally, the voice print may be updated and calibrated in a predetermined time period (e.g., daily, monthly, seasonally, yearly, etc.) to account for and learn the subtle intricacies of each teacher’s voice. When audio is received, the system may determine whether the audio is the teacher’s voice by comparing it to the stored voice print. If audio inputs include multiple speakers (e.g., more than one, a student and a teacher, etc.), speakers not identified as the teacher may be filtered out and ignored. Audio from instructional content (e.g., videos) may be flagged for the system to track, such that audio from instruction content or other media resources may be included. A non-teacher speaker may be identified by a mismatch between the speaker and the stored voice print. In some embodiments, the voice print is utilized to allow only data to be passed to the processors that conform to the teacher’s voice print.

The method 300 may also include analyzing (310) the plurality of audio inputs for one or more of an event including one or more types of content, such as behavior content, attendance content, engagement content, participation content, special education content, or lesson/mastery content. A behavior content may include information relating to actions (desirable or undesirable) taken by a particular student. The behavior content may be triggered by statements spoken by the teacher such as, “Student A, stop hitting;” “Student B, thank you for listening;” “Student C, looks like you’ve completed the assignment;” and/or “Student D, I have received your permission slip.” Behavior content may also include student activities, such as obtaining a hall pass to leave class for a short period of time (e.g., a bathroom hall pass, etc.). Additionally, behavior content may include student activities that contribute to a classroom economy, such as a student earning points or classroom currency based on achievements (e.g., helping another student, cleaning up a desk area, coming to class on time, completing homework, etc.).

Other types of events relating to student activities or actions may be included in behavior content. In some embodiments, behavior content may correspond to notes or comments made by (e.g., spoken by) the teacher or educator about a particular student, and these notes or comments may be incorporated into academic progress content or a grading process carried out by the teacher or educator and collected by the system. Notes for individual students may be stored in the system, such as stored in a profile for the individual students or within a profile for a set of students in a class. Notes for individual students may be stored anonymously and can be de-anonymized through a private name key. Additionally, and/or alternatively, to protect privacy, an anonymized segment may be produced by redacting detected person references while generating a private name key for controlled de-anonymization in later stages. In some embodiments, a securely-stored primary version of the data may be non-anonymized and/or an anonymized/redacted transcript may be cached.

To protect privacy while preserving utility, the system may use a two-track transcript representation: (i) a securely stored primary transcript and (ii) an anonymized working transcript. Detected person references are replaced with stable pseudonymous identifiers, while a private name key—a cryptographically protected mapping between pseudonyms and canonical records—is maintained in secure memory. The private name key supports controlled de-anonymization only within the event formation and integration stages running in a trusted environment. This data structure prevents inadvertent disclosure of personally identifiable information in intermediate processing and enables policy-driven access control over re-identification events. The anonymization and controlled de-anonymization pipeline is integral to the transformation of unstructured speech into structured events and is not a mere post-processing step.

Trigger words, phrases, or concepts (collectively, “event-related audio transcription”) may be locally stored and/or correlate to pre-programmed categories of content. Upon detection of one or more event-related audio transcription, one or more systems compare the spoken words to the event types to determine what category of content is included in the plurality of audio inputs. For example, detection of the words, “Student A, stop hitting,” may be compared to the database for matching between the spoken words and any event-related audio transcription or event types. If there is a match (e.g., detected “hitting” and “hitting” is stored in the database or deduced by the large language model or artificial intelligence algorithms), the match will determine which category of event types the plurality of audio inputs include. “Hitting” may be stored in the database and pre-programmed as a behavior content, or may be deduced by the artificial intelligence system or algorithms. When the word “hitting” is detected, the plurality of audio inputs will be analyzed as containing behavior content.

Additionally, and/or alternatively, event-related audio transcription may be incorporated into instructions provided to systems of the present disclosure to train the disclosed systems. The event-related audio transcription and/or instructions may be kept in a large language model used to train the system. Such training allows disclosed systems to semantically recognize marker phrases as opposed to simple keyword matching.

Additionally, and/or alternatively, event types may include definitions, categories, and other taxonomy which are provided to systems of the present disclosure to train the disclosed systems. These event types, event-related audio transcription, and/or instructions may be kept in a large language model used to train the system. Such training allows disclosed systems to semantically recognize and create taxonomy-defined data, information, or summaries for display, synthesis, or transmission as opposed to simple keyword matching.

The method 300 may also include continuously performing a real-time analysis of the entire continuous audio stream (or transcription thereof), performing semantic processing on the continuous audio stream (or transcription thereof), and determining if the audio input includes one or more events corresponding to one or more types of content (e.g., behavior content, attendance or tardy content, special education content, engagement content, acknowledgment of student participation or praise, student mastery, curriculum content, hall pass monitoring content, substitute teaching content, classroom economies, lesson content, or other appropriate content). Semantic processing by the system may include any suitable known methods, including extracting events based on training of a large language learning model with particular event-related audio transcription, etc. The event-related audio transcription may also be analyzed from fragments of the audio stream that may or may not have been transcribed.

Each of the plurality of audio inputs may be determined to include more than one type of event that may include or correspond to one or more types of content. For example, upon detection of one or more event-related audio transcriptions, the systems will analyze and process a first number of words coming before the detected event-related audio transcription and a second number of words coming after the event-related audio transcription. In the phrase, “Student A, stop hitting,” the system may detect the word “hitting” and contextualize the word into behavior data or information for the specific Student A. This analysis classifies the particular audio input as including both a behavior content and content regarding a specific student.

An attendance content may include information regarding which students are present in or absent from school or a particular class for the day. The attendance content may be triggered by statements spoken by the teacher such as, “Student A is present today,” or “Student B is absent today,” or “everyone is here today except Student C,” or “Great! Everyone is here today.” Semantic processing also allows attendance to be taken from inferred audio such as “Student D, please read this aloud for the class.” That is, semantic processing recognizes relational or inferential information regarding one or more students and is capable of utilizing such relational and/or inferential information to track attendance for students, individually, and the class as a whole.

An engagement content may include information regarding participation by one or more students with the teacher or educator, with other students, and/or with lesson content or demonstrated mastery of provided materials (e.g., topics for discussion, completion of homework assignments above a threshold grading level, etc.). The engagement content may be triggered by statements spoken by the teacher such as, “What a great question, Student A,” or “Student B, we haven’t heard from you yet today, what do you think?” Similarly, semantic processing allows engagement content and engagement events to be taken from inferred audio inputs, such as “Student C, can you build on what Student D was saying?”

A lesson content may include information regarding substantive curriculum content provided to the students by the teacher or through media shared by the teacher (e.g. video content). The lesson content may be triggered by statements spoken by the teacher such as, “Today we will be discussing fractions,” or “Please open your history textbooks to page 394.”

Processing the plurality of audio inputs may include receiving a first audio input and identifying a first content (e.g., a behavior content, an attendance content, an engagement content, a lesson content, and other types of events and content, etc.) from the first audio input. Processing the plurality of audio inputs may also include determining whether the first content is one of the behavior content, the attendance content, the engagement content, a lesson content or other types of events and content. Additionally, and/or alternatively, processing the plurality of audio inputs may include identifying a content from the plurality of audio inputs, the content being one of a behavior content, an attendance content, an engagement content, a lesson content, or other types of events and content. Processing may further include analyzing the content from the plurality of audio inputs and categorizing the content as one of a behavior content, an attendance content, an engagement content, a lesson content or other types of events and content.

The method 300 may further include determining (315) one or more suggested outputs based on the processed plurality of audio inputs. The suggested outputs may include suggestions for the teacher and/or suggestions for one or more students. For example, a suggested output for the teacher may include a suggestion to revisit fractions for Student A because Student A is struggling to understand the concept. Additionally, and/or alternatively, a suggested output for a student may be a worksheet of practice fractions that are tailored to the student’s competency with fractions (e.g., easy, medium difficulty, hard, etc.).

Additionally, the method 300 may include generating (320) a summary of one or more of the plurality of audio inputs based on the processed plurality of audio inputs. Generating a summary may include generating a summary of student-specific behavior content and/or attendance content, and/or generating a summary of class-specific lesson content.

Additionally, and/or alternatively, generating a summary may include receiving a plurality of categorized content and grouping the plurality of categorized content by behavior content, attendance content, engagement content, lesson content, or other types of events and content. One or more of the grouped behavior content, grouped attendance content, grouped engagement content, and grouped lesson content may be analyzed and, based on the analysis, summarized. The method 300 may further include incorporating (325) at least a portion of the summary into an educational administrative system. In some embodiments, the entire summary is incorporated into the educational administrative system.

Incorporating at least a portion of the summary into the educational administrative system may include transcribing the portion of the summary and converting the transcribed portion of the summary into a structure readable by the educational administrative system. The converted portion of the summary is then sent to the educational administrative system to be incorporated therein. Incorporating at least a portion of the summary can also include filtering the transcribed portion of the summary for behavior content, attendance content, engagement content, and lesson content specific to a first student to create a first student summary. That is, the generated summary may be filtered for information regarding a particular student (e.g., the first student) and a summary may be generated for that particular student (e.g., the first student summary). The first student summary can be incorporated into a file for the first student, which is stored within the educational administrative system.

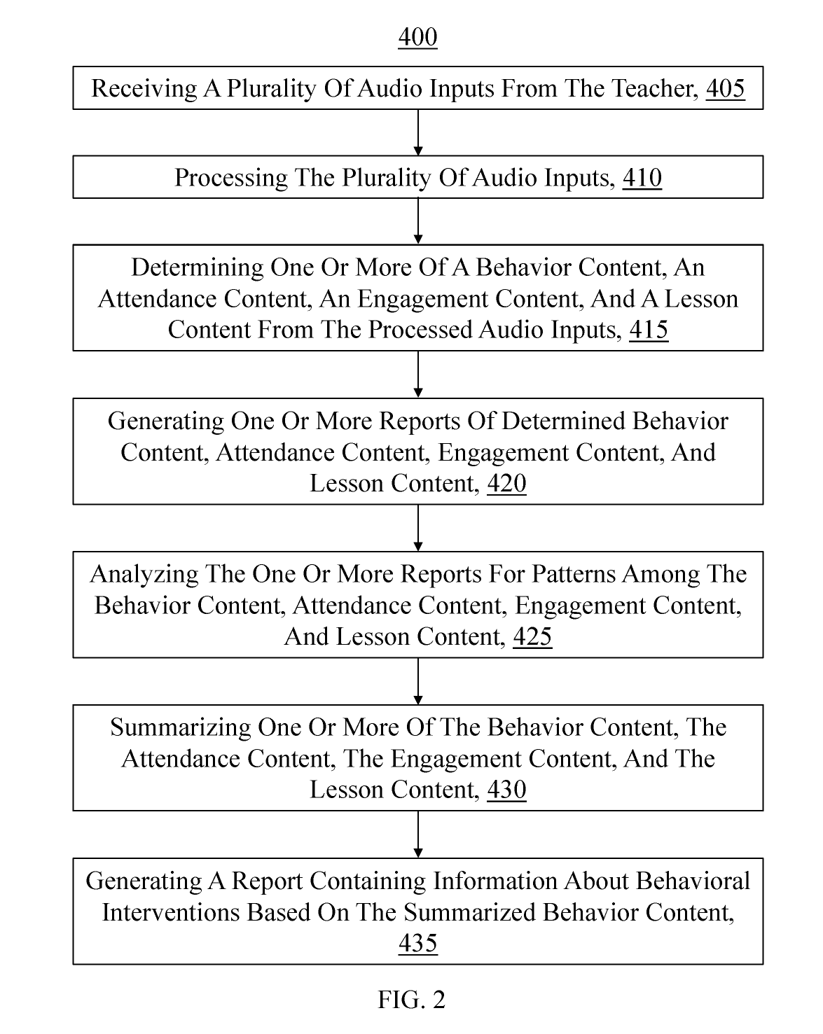

FIG. 2 is a flowchart of another example method 400 of assisting a teacher. The method 400 may include receiving (405) a plurality of audio inputs from the teacher. The plurality of audio inputs may be received by at least one input device, such as a microphone device (e.g., a smartphone microphone, a microphone headset, a lapel microphone, other types of microphones, etc.) or a camera. In some embodiments, the at least one input device is worn by the teacher. The method 400 may also include processing (410) the plurality of audio inputs and determining (415) one or more of a behavior content, an attendance content, an engagement content, a lesson content, and/or other types of content from the processed audio inputs.

As before, processing the plurality of audio inputs and determining the content of the audio inputs may include identifying content from the audio inputs, categorizing the identified content, and grouping the content by one or more of behavior content, attendance content, engagement content, lesson content and/or other types of content. The grouped content can be analyzed and then summarized accordingly.

The method 400 may further include generating (420) one or more reports of determined behavior content, attendance content, engagement content, lesson content, and/or other types of content. Still further, the method 400 may include analyzing (425) the one or more reports for patterns among the behavior content, attendance content, engagement content, lesson content, and/or other types of content. Additionally, the method 400 may include summarizing (430) one or more of the behavior content, attendance content, engagement content, lesson content, and/or other types of content. The method 400 may include generating (435) a report containing information about behavioral interventions based on the summarized behavior content.

Summarizing one or more of the behavior content, the attendance content, the engagement content, and the lesson content may include summarizing behavior content for an individual student. Additionally, and/or alternatively, summarizing one or more of the behavior content, the attendance content, the engagement content, the lesson content, and/or other types of content includes summarizing lesson content for a class. Still additionally, and/or alternatively, summarizing one or more of the behavior content, the attendance content, the engagement content, the lesson content, and/or other types of content includes summarizing attendance content for a class. The method 400 may include filtering out audio inputs that are not from the teacher, such as audio inputs spoken by a student or staff member.

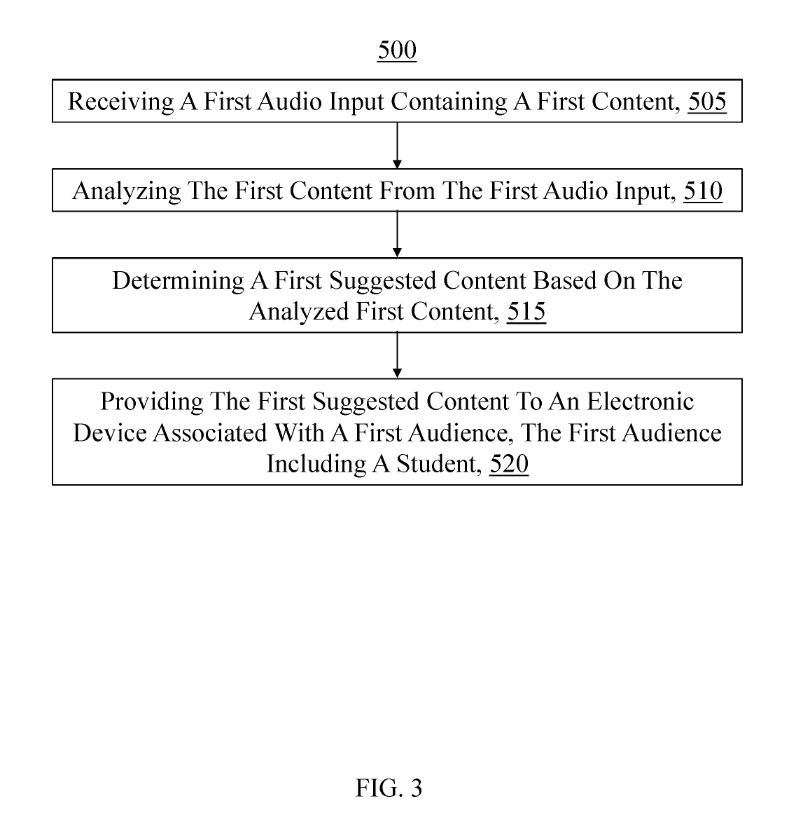

FIG. 3 is a flowchart of another example method 500 of assisting a teacher. The method 500 may include receiving (505) a first audio input containing a first content. The method 500 may also include analyzing (510) the first content from the first audio input. Further, the method 500 may further determining (515) a first suggested content based on the analyzed first content and providing (520) the first suggested content to an electronic device associated with a first audience, where the first audience is a student. Additionally, and/or alternatively, the first audience may include a group of students (e.g., designated groups of students, students who have yet to participate in class, absent students, etc.), all students in a class, parents, other educators, or another appropriate audience.

Determining a first suggested content may include receiving an age of the student, receiving a language of the student, receiving a comprehension level of the student, and determining the first suggested content based on the age, the language, and/or the comprehension level of the student. In this way, customized content can be delivered to the electronic device associated with the student, allowing the student to engage with the teacher and the lessons taught at a level appropriate for the student. That is, a first student may receive suggested content that correlates to a reading comprehension for the first student and a second student may receive suggested content that correlates to a reading comprehension for the second student. This allows each student in a class to be appropriately challenged and engaged with the substantive material taught during a lesson. Content may also include, for example, questions or comments directed to non-participating students.

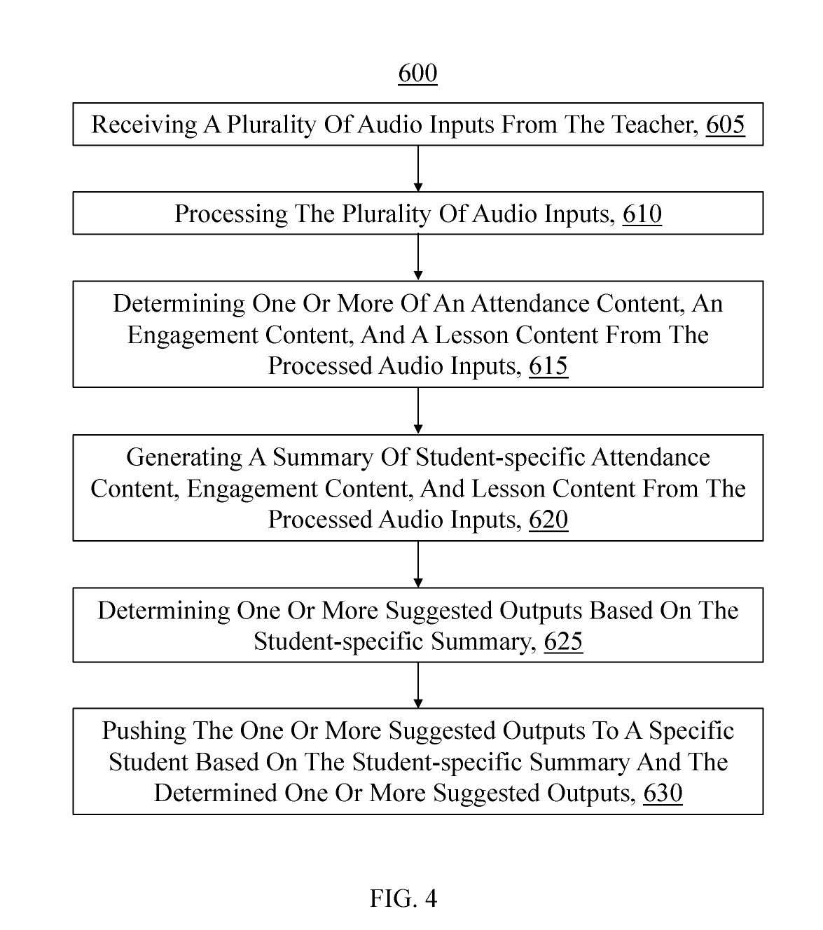

FIG. 4 is a flowchart of another example method 600 of assisting a teacher. Similar to methods 300, 400, and 500, the method 600 may include receiving (605) a plurality of audio inputs from the teacher and processing (610) the plurality of audio inputs. The method 600 may also include determining (615) one or more of a behavior content, an attendance content, an engagement content, a lesson content, and/or other types of content from the processed audio inputs. Additionally, the method 600 may include generating (620) a summary of student-specific behavior content, attendance content, engagement content, lesson content, and/or other types of content from the processed audio inputs. Further, the method 600 may include determining (625) one or more suggested outputs based on the student-specific summary and pushing (630) the one or more suggested outputs to a specific student based on the student-specific summary and the determined one or more suggested outputs. The one or more suggested outputs may be pushed or provided to an electronic device associated with the specific student.

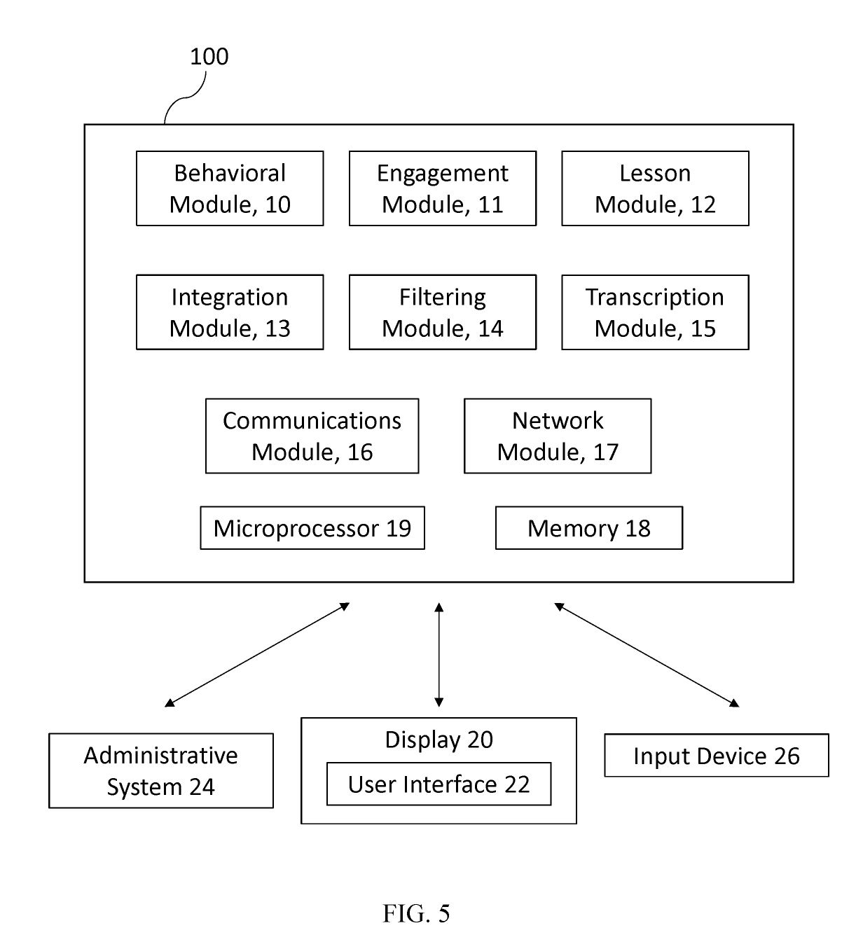

FIG. 5 schematically illustrates a block diagram of a system 100 capable of performing any of the methods described herein. The system 100 may execute and/or include a logical architecture. As illustrated, the system 100 includes a behavioral module 10, an engagement module 11, a lesson module 12, an integration module 13, a filtering module 14, a transcription module 15, a communications module 16, a network module 17, memory 18, and at least one microprocessor 19. The system 100 may be in communication with a display 20 having a user interface 22, an administrative system 24, and an input device 26. The input device 26 may be a microphone device or other audio input device. The user interface 22 may allow a teacher to interact with the system 100, such as making a request for a specific report or summary. Additionally, and/or alternatively, the system 100 may be in communication with a plurality of displays 20 each having a user interface 22 (not illustrated) for a student, parent, or other educator to interact with the system 100.

The memory 18 stores, among other things, instructions that are executable by the at least one (e.g., one or more) microprocessor(s) 19. The instructions cause the at least one microprocessor 19 to track audio inputs received by the at least one input device; analyze the audio inputs for one or more of a behavior content, an attendance content, an engagement content, a lesson content, and/or other types of content; generate one or more summary reports corresponding to analyzed audio inputs; push the one or more summary reports to the teacher; generate one or more suggestions based on the analyzed audio inputs; and push the one or more suggestion to one or more students. That is, the instructions cause the at least one microprocessor 19 to execute or perform any of the methods 300, 400, 500, and/or 600 described herein.

As described, the system 100 listens to and tracks a teacher’s voice throughout a school day. As the teacher is speaking, the system 100 will listen to and process the audio inputs provided by the teacher. For example, the behavioral module 10 will listen for and process audio inputs spoken by the teacher related to the behavior of one or more students in the classroom. The behavioral module 10 will log these instances of behavior-related audio both for the class as a whole, as well as for the individual students named and mentioned by the teacher.

The engagement module 11 will listen for and process audio inputs spoken by the teacher related to engagement or interaction of one or more students in the class with the material being taught or delivered by the teacher. The engagement module 11 will log these instances of engagement-related audio both for the class as a whole, as well as for the individual students named and mentioned by the teacher.

The lesson module 12 will listen for and process audio inputs spoken by the teacher related to substantive lesson material delivered by the teacher (or media facilitated by the teacher). The lesson module 12 will log these instances of substantive lesson audio both for the lesson material as a whole, as well as for assignments created by the teacher that correlate to the lesson material.

The integration module 13 receives information from other components or modules of the system 100 and provides information to larger, educational administrative systems. The integration module 13 may have access (e.g., readable, writable, etc.) to one or more databases within the system 100 (e.g., a local database stored within the memory 18) and the larger, educational administrative system. This allows the integration module 13 to build and augment summaries for individual students that are stored in the larger, educational administrative system. This also allows the integration module 13 to perform various comparison steps in order to accurately augment summaries for students, the class, etc. For example, the integration module 13 may compare processed audio inputs from the teacher to data structures to determine whether the processed audio inputs relate to attendance, student behavior, etc., and then incorporate the processed audio inputs into a summary as appropriate.

In certain embodiments, the system’s integration module performs authenticated, transactional writes to external educational administrative systems via idempotent API calls that include event identifiers and version stamps. Attendance events are committed by invoking a write endpoint that updates the student’s daily attendance record; behavior and engagement events are committed to corresponding intervention or coaching modules. Each write is accompanied by a policy check that enforces role-based restrictions and compliance logging. These operations cause a concrete change in the state of external systems and initiate automated administrative workflows (for example, triggering an absence notification rule), demonstrating a practical application beyond mere data reporting.

The filtering module 14 will listen for and identify audio inputs spoken by the teacher and may filter out audio inputs that are not spoken by the teacher. That is, the filtering module 14 allows the system 100 to ignore audio inputs that are not spoken by the teacher (e.g., the sound of a bell, audio inputs spoken by a student, etc.). The filtering module 14 may also identify and track audio inputs that are associated with a particular student, allowing the system 100 to track behavior, attendance, engagement, etc. for the particular student. Put another way, some embodiments of the filtering module 14 tag audio inputs based on the identified speaker or subject of the audio inputs. This tagging allows other modules of the system 100 (e.g., the integration module 13) to sort and categorize the audio inputs for incorporation into report provided to the teacher or to augment student-specific summaries stored in the larger, educational administrative system.

The transcription module 15 transcribes audio inputs and processes them into a format readable and storable to the larger, educational administrative system. The transcription module 15 also provides processed audio inputs in a format that is readable and usable by other modules of the system 100 (e.g., the integration module 13, etc.)

The communications module 16 allows the system 100 to talk to and communicate with the larger, educational administrative system as well as electronic or other devices associated with, for example, students. For example, when the system 100 creates a customized content to be delivered to a particular student, the communications module 16 delivers that customized content to an electronic device associated with that particular student. The communications module 16 may also facilitate communication to an electronic device associated with a parent of the particular student, such as by sending a weekly attendance record of the particular student to the parent via email.

The network module 17 facilitates connection of the system 100 to a Wi-Fi or other internet network. The network module 17 may also facilitate connection of the system 100 to a Bluetooth or other radiofrequency-based network. For example, the network module 17 facilitates Bluetooth connection between the system 100 and an electronic device associated with a student, such that the communications module 16 can provide and deliver customized content to the electronic device via Bluetooth.

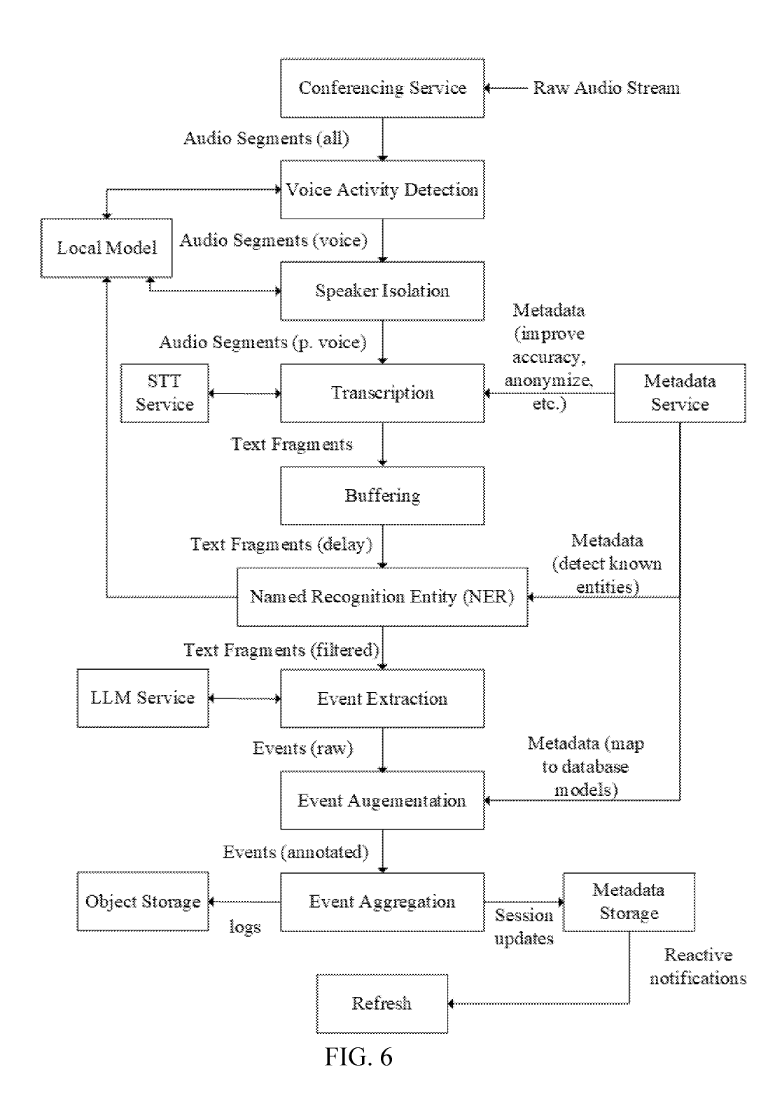

FIG. 6 schematically illustrates a workflow performed by the system of FIG. 5 and corresponding to at least portions of the methods described with respect to FIGS. 1-4. The workflow starts with an incoming stream of raw audio that is received by a conferencing service. The conferencing service provides all audio segments (e.g., sounds of the bell, voices in the hallway, audio spoken by the teacher, audio spoken by students, etc.) to a voice activity detection service. The voice activity detection service may detect audio inputs that correlate to voices or speech (e.g., that contain human voices) and ignore audio inputs that do not correlate to voices or speech.

Audio segments that correlate to voices or speech are sent to a speaker isolation service. The speaker isolation service processes the audio segments correlating to voices and speech, and filters out or ignores audio segments that do not correspond to a specific voice or person, such as a single pre-identified speaker. For example, the speaker isolation service may ignore and filter out audio segments that are spoken by a student. The filtered audio segments that correspond to a specific or particular voice (e.g., the teacher’s voice) are sent to a transcription service. Additionally, and/or alternatively, the speaker isolation service may receive an input indicating that a particular media resource (e.g., an instructional video, etc.) is to be included as part of, for example, lesson content. In this way, the speaker isolation service may retain and track the media resource rather than ignoring the media resource.

The transcription service receives the filtered audio segments that correspond to a specific or particular voice in order to transcribe the filtered audio segments. That is, the transcription service converts the audio data into text data. The transcription service also receives metadata, from a metadata service, in order to improve the accuracy of the transcription, to anonymize the transcription, etc. The transcription service is also in communication with a speech-to-text (STT) service. The STT service may fragment the transcription into transcribed text fragments. The transcription service sends transcribed text fragments to the buffering service.

The buffering service receives many text fragments and holds them for filtering. That is, the buffering service accumulates multiple frames of data in memory for a short period of time to delay processing until enough data is present. For example, the buffering service sends text fragments to a named recognition entity (NER) that filters the text fragments. The NER may filter the text fragments based on a type of content contained (e.g., behavior content, attendance content, etc.). The NER may also filter the text fragments based on the subject of the text (e.g., Student A, Student B, etc.). The NER then sends the filtered text fragments to an event extraction service. The NER may identify, from the text fragments, names, dates, locations, and/or other entities.

The event extraction service may use large language modeling (LLM) to extract structured information in a predetermined, machine-understandable format from freeform textual data. The event extraction service may categorize the text fragments based on detected events. For example, text fragments including information such as “Student A, hitting,” may be extracted and categorized as behavioral text fragments. As another non-limiting example, text fragments including information such as “Student A, absent,” may be extracted and categorized as attendance text fragments. These categorized text fragments may be sent to an event augmentation service.

The event augmentation service is an infrastructure that stores and persists the raw/collected set of events that have occurred in the session. This provides resiliency to the workflow and the system (e.g., system 100) performing the workflow. Importantly, the event augmentation service does not provide analytics. Rather, the event augmentation service may annotate structured events with additional metadata that allow field to be related to known objects in a database. The event augmentation service may label all instances of behavior events, attendance events, lesson events, student-specific events, etc. The event augmentation service is in communication with the metadata service and may receive from the metadata service information related to mapping of database models.

The event augmentation service will send annotated events to an event aggregation service. The event aggregation service may provide an analytical function, allowing annotated events to be compiled into logs or reports that are stored in, for example, object storage. Additionally, and/or alternatively, the event aggregation service may provide (e.g., write, etc.) updates to a metadata storage. When the workflow is refreshed, the metadata storage provides the newest or most up-to-date version of the information.

For example, the event aggregation service ties together all events related to Student A and compiles all events related to Student A in one report or summary. This may include mapping the compiled events related to Student A to a student row contained within a database. As another non-limiting example, the event augmentation service ties together all attendance-related events and compiles all attendance-related events in one report or summary. The event augmentation service may take unstructured text from the event extraction service and convert it to structured text, that may include links to database objects.

The metadata service provides reading, writing, and data retrieval functions. For example, students, rosters, accounts, etc. may be read, written to, and retrieved from the metadata service. The metadata service may also store categories or taxonomies for text fragments or events, allowing other services to read the taxonomies and properly categorize the text fragments or events. The metadata service may provide a source of truth for all data used to operate the workflow and for all data produced during the workflow.

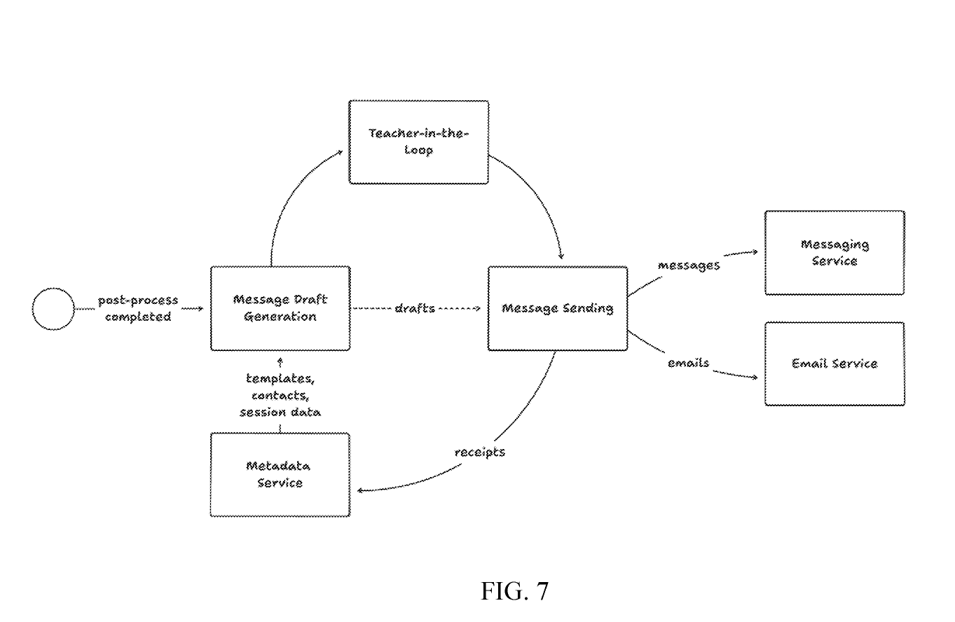

FIG. 7 illustrates a feedback loop performed as part of any of the methods described herein and/or as part of the workflow of FIG. 6 performed by the system of FIG. 5. Specifically, the system 100 may generate a draft message to be sent to an audience (e.g., a student, a parent, the school administrator, etc.). The message drafted may pull from information stored in the metadata service (e.g., templates, contacts, specific session data, etc.). The teacher may be provided with the draft message to approve or modify before sending the message. Upon approval, the system 100 may send the message to the recipient(s), such as through a message service of an email service. A receipt of the message sent may be stored and logged to the metadata service.

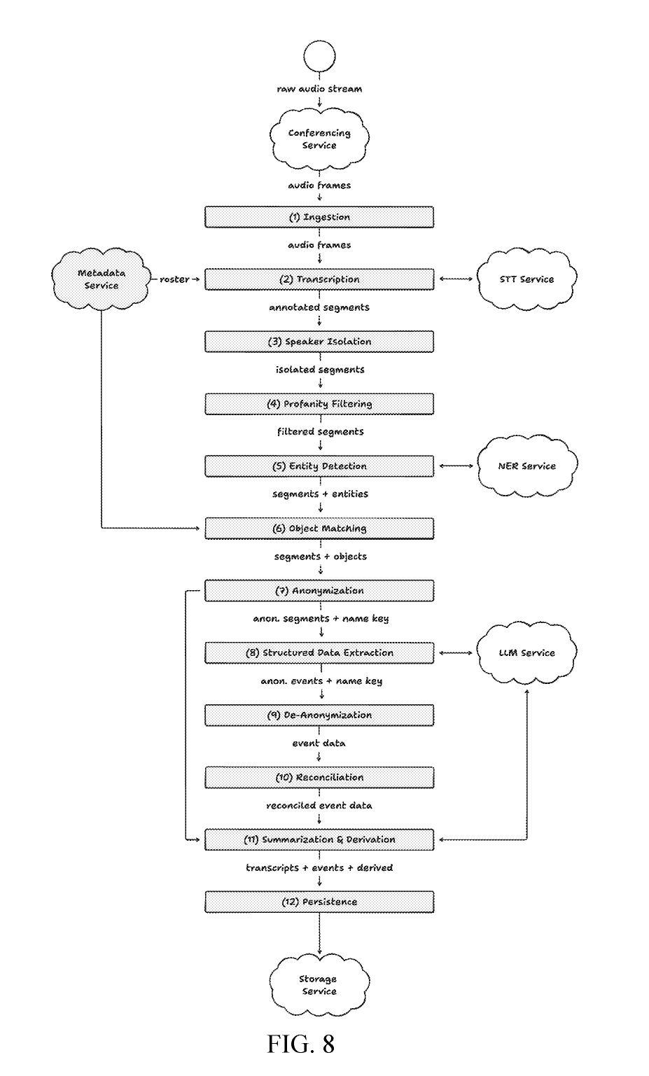

FIG. 8 schematically illustrates a workflow performed by the system of FIG. 5 and corresponding to at least portions of the methods described with respect to FIGS. 1-4. In one embodiment, a classroom audio processing system (i) receives a live stream of a teacher’s voice from an input device via an audio conferencing interface and (ii) ingests that stream into an agent-based processing pipeline configured to transform unstructured speech into structured educational events suitable for downstream administrative use. The system continuously transcribes incoming raw audio into text while performing speaker isolation and teacher identification, so that non-primary voices are filtered or deprioritized, enabling the pipeline to focus on teacher-led utterances that drive educational and administrative records. Transcribed segments are buffered and selectively released once a primary speaker is confirmed, after which the text proceeds through a cleaning and normalization stage and into a named-entity recognition module that extracts candidate person names and other entities with associated confidence values. The system then reconciles detected entities against a roster retrieved from a metadata service that functions as a source of truth for students, rosters, and related taxonomies, thereby aligning mentions with the correct student records and enabling robust event formation tied to specific database objects. To protect privacy, the pipeline can produce an anonymized segment by redacting detected person references while generating a private name key for controlled de-anonymization in later stages.

Using anonymized text, the system applies prompt-driven large language models to extract structured events—such as attendance, engagement, and behavior—from the segment stream, intentionally designed to map teacher utterances into taxonomically defined categories that the educational ecosystem can consume without ambiguity. The resulting events are de-anonymized using the private name key and then analyzed as a temporal sequence, allowing the system to adjust or augment events for correctness and coherence. For example, behavior-related observations can corroborate or influence inferred attendance status based on relational cues in the teacher’s speech. The pipeline persistently aggregates session events to ensure resiliency and enable later retrieval, while maintaining a separation between event storage and higher-level analytics to support a variety of integration patterns. From the combined transcript and event corpus, the system computes derived outputs such as action items, daily summaries, and follow-ups, capturing notes about individual students and accomplishments as well as broader classroom-level outcomes.

The generated structured data is formatted for seamless interoperability with academic and administrative systems, including attendance, behavioral intervention, and engagement platforms, by aligning event types with the metadata service’s taxonomies and persisting links to the relevant student records. With appropriate teacher permissions, the system securely pushes data, actions, and summary reports—in whole or in role-tailored subsets—to teachers, school leaders, administrators, and parents, ensuring that each stakeholder receives information calibrated to their needs and responsibilities. For example, the system can transmit confirmed attendance updates to the attendance system, behavior insights to coaching or intervention modules, and concise summaries to parents of absent students, while preserving a comprehensive educator-facing view that includes structured events, derived insights, and recommended follow-ups.

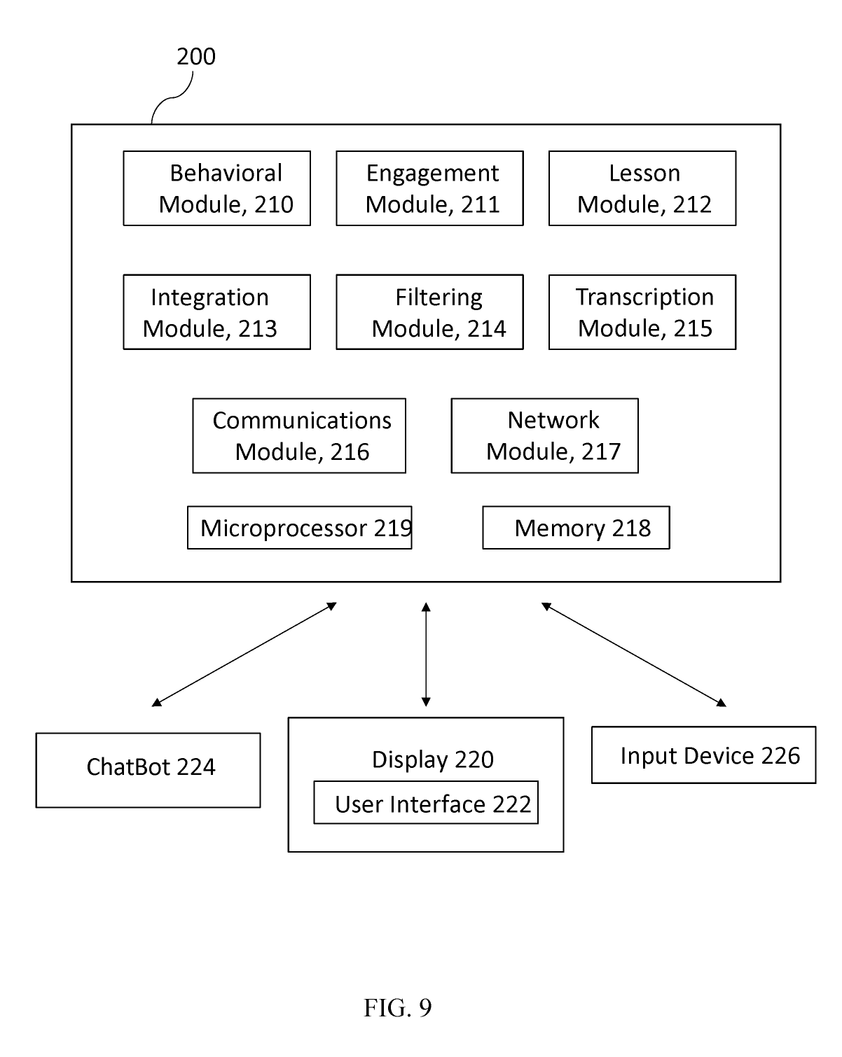

FIG. 9 schematically illustrates a block diagram of another system 200 capable of performing the methods and workflows described herein. The system 200 is substantially identical to the system 100 illustrated in FIG. 5. However, the system 200 utilizes or incorporates a chat-bot functionality 224. The chat-bot functionality allows users of the system 200 (e.g., teachers, principals, administrators, teacher aides, or other personnel) to query the system 200. The chat-bot functionality 224 safely interacts with the data stored and generated by the system 200 by anonymizing the data before a user interacts with the chat-bot functionality 224. The chat-bot functionality 224 enables users to review data stored and generated by the system 200 based on the voice data collected. For example, a teacher may query the chat-bot functionality 224 regarding a particular subject discussed in a particular class session captured in the voice data. In some embodiments, the chat-bot functionality 224 can generate action items for the user based on data stored and generated by the system 200 as well as on the queries input by the user. For example, when a user queries the chat-bot functionality 224 regarding student test results, the chat-bot functionality 224 can generate an action item of entering student grades into the system 200 or reporting student grades to other users of the system (e.g., other educators, teacher aides, parents, or other personnel). Task content may be an event type that represents teacher-issued actions, including assignments, due dates, reminders, and post-class follow-ups. Task events include fields such as task_id, description, due_date, assignee_set, and source_utterance_time, and can trigger automated reminders or parent notifications according to policy. Task content is extracted and validated using the same schema-constrained mechanism described for other event types.

In certain embodiments, the classroom audio processing pipeline is implemented as a finite-state streaming architecture executing on distributed compute resources, including an edge device co-located with the input device and a backend event server. The pipeline includes:
1. A voice activity detection (VAD) stage that consumes raw audio frames (e.g., 20–40 ms windows) and discards non-speech segments to reduce downstream compute. The VAD uses a fixed-point inference engine on the edge device to maintain a target latency under 10 ms per frame.
2. A speaker isolation and teacher-identification stage that performs gated feature extraction (e.g., MFCCs or log-mel spectrograms) and a cosine-similarity comparison against an enrolled teacher voiceprint vector. Only segments with a similarity above a tunable threshold τT are forwarded to the speech-to-text (STT) stage; other segments are discarded at the edge, which reduces unnecessary network transmission and protects student privacy.
3. A constrained STT stage that operates in streaming mode with partial hypotheses stabilized via a commit rule requiring N successive consistent tokens. The STT operates with a domain-optimized language model incorporating course vocabulary and roster-derived proper nouns to improve word error rate (WER) on targeted terms.
4. A named-entity recognition (NER) and roster reconciliation stage that maps extracted entities to canonical student records using a bipartite matching constrained by homophone rules and class roster context. Mentions that do not meet a confidence threshold are held in a pending buffer for clarification before any write operation occurs.
5. A schema-constrained event extraction stage that uses prompt-bounded large language models configured to emit only a strict event schema (for example, JSON conforming to a published JSON Schema), enforced by a deterministic validator. Outputs failing validation are automatically re-prompted with corrective constraints until they conform, ensuring deterministic downstream ingestion.
6. A temporal reconciliation and aggregation stage that applies vector-clock ordering or timestamp bucketing to merge overlapping fragments into a single event timeline, with conflict resolution rules that prioritize higher-confidence sources and explicit teacher confirmations when available.
7. This staged pipeline materially improves computational efficiency and accuracy over conventional continuous-recording systems by eliminating non-teacher speech before STT, thereby reducing WER, token throughput, and GPU utilization. The technical effect is a reduction in end-to-end latency (for example, median latency under 200 ms from utterance to event object availability) and decreased network egress from the classroom device.

In some embodiments, the edge device performs VAD, teacher gating, and first-pass STT locally to minimize network bandwidth and to maintain functionality during intermittent connectivity. Buffered transcripts and provisional events are persisted in a write-ahead log with sequence numbers and are reconciled with the backend upon reconnection. Resource-aware scheduling limits CPU and memory usage to configured budgets (for example, <30% CPU and <256 MB RAM for audio tasks), ensuring real-time responsiveness without preempting other device functions.

Although machine learning models are employed in some embodiments, the system can operate in a fully deterministic mode that uses rule-based keyword spotting, phonetic matching, and finite-state grammars derived from teacher-provided vocabularies and taxonomies. In deterministic mode, the pipeline still performs the gated acquisition, schema-constrained event emission, and transactional integrations described above, preserving the computer-centric improvements independent of any abstract “reasoning” by an ML model.

In a representative deployment, the voiceprint gating reduced tokenized audio passed to STT by approximately 60–80% relative to unfiltered streams, yielding a 35–45% reduction in GPU seconds per class session and a 20–30% reduction in WER for teacher utterances due to decreased crosstalk. End-to-end median latency from utterance to a validated event object was reduced to under 200 ms, enabling near-real-time attendance writes and timely intervention prompts.

Comparative Example A (baseline): A continuous-recording pipeline without speaker gating transcribes all classroom audio and performs post hoc entity extraction. Under mixed-speaker conditions, the system exhibits high crosstalk-induced errors and frequent misattribution of engagement events.

Example 1 (disclosed system): With VAD and teacher voiceprint gating at τT = 0.83, only teacher-aligned segments enter STT. NER confidence improves for student names due to a narrowed hypothesis space, and constrained event extraction produces schema-valid events on the first pass in 92% of cases. Attendance writes complete within 300 ms of utterance “Present,” with idempotent retries in the event of network jitter.

In certain embodiments, event extraction uses structured prompting that enumerates permissible event types (attendance, engagement, behavior, lesson/mastery, and task) and permissible fields for each type. The generator is restricted to these enumerations, and outputs are validated against the schema. If a field is missing or incorrectly typed, the validator supplies a corrective message and re-invokes the generator with targeted constraints. This loop continues until a valid event is produced or a timeout occurs, ensuring deterministic compliance with downstream interfaces.

In another aspect, a non-transitory computer-readable medium stores instructions that, when executed by one or more processors, cause the processors to perform any of the methods described herein, including gated audio acquisition using a stored voiceprint, constrained transcription and entity extraction, schema-validated event generation, privacy-preserving anonymization with a private name key, and authenticated transactional writes to educational administrative systems.

### Additional Terms and Definitions

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It should also be noted that some of the embodiments disclosed herein may have been disclosed in relation to a particular setting (e.g., a classroom); however, other settings (e.g., board meetings, club meetings, coaching sessions, conferences, etc.) are also contemplated.

In one embodiment, the terms “about” and “approximately” refer to numerical parameters within 10% of the indicated range. The terms “a,” “an,” “the,” and similar referents used in the context of describing the embodiments of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the embodiments of the present disclosure and does not pose a limitation on the scope of the present disclosure. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the author(s) of this disclosure for carrying out the embodiments disclosed herein. Of course, variations on these described embodiments will become apparent to those of ordinary skill in the art upon reading the foregoing description. The author(s) expects skilled artisans to employ such variations as appropriate, and the author(s) intends for the embodiments of the present disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of this disclosure so claimed are inherently or expressly described and enabled herein.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed is:

1. A method of assisting a teacher, the method comprising:
tracking a plurality of audio inputs, the plurality of audio inputs spoken by the teacher;
processing the plurality of audio inputs for one or more of a behavior content, an attendance content, an engagement content, and a lesson content;
determining one or more suggested outputs based on the processed plurality of audio inputs;
generating a summary of one or more of the plurality of audio inputs based on the processed plurality of audio inputs; and
incorporating at least a portion of the summary into an educational administrative system.

2. The method of claim 1, wherein tracking a plurality of audio inputs comprises:
receiving a first audio input;
identifying a first speaker of the first audio input;
receiving a second audio input;
identifying a second speaker of the second audio input;
determining which of the first speaker and the second speaker is the teacher; and
ignoring audio inputs that are not from the teacher.

3. The method of claim 2, wherein determining which of the first speaker and the second speaker is the teacher comprises:
comparing the first audio input to a voice print of the teacher;
comparing the second audio input to the voice print of the teacher; and
determining a match between the first audio input or the second audio input and the voice print of the teacher.

4. The method of claim 1, wherein processing the plurality of audio inputs comprises:
receiving a first audio input;
identifying a first content from the first audio input;
determining whether the first content is one of the behavior content, the attendance content, the engagement content, and the lesson content.

5. The method of claim 1, wherein incorporating a portion of the summary into an educational administrative system comprises:
transcribing the portion of the summary;
converting the transcribed portion of the summary into a structure readable by the educational administrative system; and
sending a converted portion of the summary to the educational administrative system to be incorporated therein.

6. The method of claim 5, further comprising:
filtering the transcribed portion of the summary for behavior content, attendance content, engagement content, and lesson content specific to a first student to create a first student summary; and
incorporating the first student summary into a file for the first student, the file for the first student stored within the educational administrative system.

7. The method of claim 1, wherein processing the plurality of audio inputs comprises:
identifying a content from the plurality of audio inputs, the content being one of a behavior content, an attendance content, an engagement content, and a lesson content;
analyzing the content from the plurality of audio inputs; and
categorizing the content as one of a behavior content, an attendance content, an engagement content, and a lesson content.

8. The method of claim 7, wherein generating a summary of one or more of the plurality of audio inputs based on the processed plurality of audio inputs comprises:
receiving a plurality of categorized content;
grouping the plurality of categorized content by behavior content, attendance content, engagement content, and lesson content;
analyzing one or more of grouped behavior content, grouped attendance content, grouped engagement content, and grouped lesson content to generate an analysis; and
based on the analysis, summarizing the one or more grouped behavior content, grouped attendance content, grouped engagement content, and grouped lesson content.

9. The method of claim 1, wherein generating a summary of one or more of the plurality of audio inputs comprises generating a summary of student-specific behavior content.

10. The method of claim 1, wherein generating a summary of one or more of the plurality of audio inputs comprises generating a summary of student-specific attendance content.

11. The method of claim 1, wherein generating a summary of one or more of the plurality of audio inputs comprises generating a summary of class-specific lesson content.

12. The method of claim 1, further comprising pushing at least a portion of the summary to a parent or other stakeholder.

13. The method of assisting a teacher, the method comprising:
receiving a plurality of audio inputs from the teacher;
processing the plurality of audio inputs;
determining one or more of a behavior content, an attendance content, an engagement content, and a lesson content from the processed audio inputs;
generating one or more reports of determined behavior content, attendance content, engagement content, and lesson content;
analyzing the one or more reports for patterns among the behavior content, attendance content, engagement content, and lesson content;
summarizing one or more of the behavior content, the attendance content, the engagement content, and the lesson content; and generating a report containing information about behavioral interventions based on the summarized behavior content.

14. The method of claim 13, wherein summarizing one or more of the behavior content, the attendance content, the engagement content, and the lesson content comprises summarizing behavior content for an individual student.

15. The method of claim 13, wherein summarizing one or more of the behavior content, the attendance content, the engagement content, and the lesson content comprises summarizing attendance content for a class.

16. The method of claim 13, wherein summarizing one or more of the behavior content, the attendance content, the engagement content, and the lesson content comprises summarizing lesson content for a class.

17. The method of claim 13, wherein determining one or more of a behavior content, an attendance content, an engagement content, and a lesson content from the processed audio inputs comprises:
receiving a plurality of processed audio inputs;
identifying a content from the plurality of processed audio inputs; and
categorizing the content as one or more of a task content, a behavior content, an attendance content, an engagement content, and a lesson content.

18. The method of claim 13, further comprising filtering out audio inputs that are not from the teacher.

19. A system for assisting a teacher, the system comprising:
at least one input device;
one or more processors in communication with the at least one input device and comprising memory capable of storing instructions executable by the one or more processors, the instructions causing the one or more processors to:
track audio inputs received by the at least one input device;
analyze the audio inputs for one or more of a behavior content, an attendance content, an engagement content, and a lesson content;
generate one or more summary reports corresponding to analyzed audio inputs;
push the one or more summary reports to the teacher;
generate one or more suggestions based on the analyzed audio inputs; and
push the one or more suggestions to one or more students.

20. The system of claim 19, wherein the at least one input device comprises a wearable microphone.

21. The system of claim 19, wherein the instructions further cause the one or more processors to:
identify audio inputs generated by the teacher; and
ignore audio inputs not generated by the teacher.

22. A method of assisting a teacher, the method comprising:
receiving a first audio input containing a first content;
analyzing the first content from the first audio input;
determining a first suggested content based on the analyzed first content;
providing the first suggested content to an electronic device associated with a first audience, the first audience comprising a student.

23. The method of claim 22, wherein determining a first suggested content based on the analyzed first content comprises:
receiving an age of the student;
receiving a language of the student;
receiving a comprehension level of the student; and
determining the first suggested content based on the age, the language, and the comprehension level of the student.

24. A method of assisting a teacher, the method comprising:
receiving a plurality of audio inputs from the teacher;
processing the plurality of audio inputs;
determining one or more of an attendance content, an engagement content, and a lesson content from the processed audio inputs;
generating a summary of student-specific attendance content, engagement content, and lesson content from the processed audio inputs;
determining one or more suggested outputs based on the student-specific summary; and
pushing the one or more suggested outputs to a specific student based on the student-specific summary and the determined one or more suggested outputs.

25. A method of assisting a school administrator or leader, the method comprising:
receiving a plurality of processed audio inputs, the plurality of processed audio inputs from one or more class sessions;
determining one or more of an attendance content, an engagement content, and a lesson content from the processed audio inputs;
generating a summary of class-specific attendance content, engagement content, and lesson content from the processed audio inputs, the summary including one or more of class data, action items for the school administrator or leader, and a summarization of the class-specific attendance content, engagement content, and lesson content;
determining one or more suggested outputs based on the class-specific summary; and
pushing the one or more suggested outputs to a specific class based on the class-specific summary and the determined one or more suggested outputs.
